(19) United States
(12) Patent Application Publication
(10) Pub. No.: US 2023/0403582 A1
(43) Pub. Date: Dec. 14, 2023

(54) INTERFERENCE MITIGATION IN WIRELESS COMMUNICATION

(71) Applicant: Hewlett Packard Enterprise Development LP, Houston, TX (US)

(72) Inventors: Xuguang JIA, Beijing (CN); Jianpo HAN, Beijing (CN); Qiang ZHOU, San Jose, CA (US)

(21) Appl. No.: 17/805,932

(22) Filed: Jun. 8, 2022

(51) Int. Cl. H04W 24/08; H04W 52/24; H04W 72/08; H04W 36/30

(52) U.S. Cl. CPC H04W 24/08; H04W 36/30; H04W 72/082; H04W 52/243

(57) ABSTRACT

In embodiments of the present disclosure, a method is provided for interference mitigation in wireless communication. Radio statistics indicating transmissions between an AP and a plurality of clients are obtained at the AP. Based on the radio statistics, a client suffering from adjacent band interference is identified from the plurality of clients. An indication is transmitted to at least one other client of the plurality of clients to mitigate the adjacent band interference and the at least one other client is identified based on the client. In this way, by transmitting the indication to the client(s) associated with the client identified as suffering from the adjacent band interference, the adjacent band interference can be mitigated or eliminated efficiently.

### BACKGROUND

Recently 6 GHz band has been introduced in wireless communication to achieve high-performance connectivity. For example, Wi-Fi 6E is designed with spectrum expansion into the 6 GHz band under the Wi-Fi 6 standard. However, when an access point (AP) is designed to support a dual-band (5 GHz and 6 GHz) or a tri-band (2.4 GHz, 5 GHz, and 6 GHz), radio frequency (RF) interference may exist when 5 GHz and 6 GHz concurrent transmissions happen due to a narrow channel space between the 5 GHz band and 6 GHz band. Thus great efforts are needed to mitigate adjacent band interference caused by concurrent transmissions on adjacent bands such as the 5 GHz band and 6 GHz band.

### BRIEF DESCRIPTION OF THE DRAWINGS

Embodiments of the present disclosure may be understood from the following Detailed Description when read with the accompanying Figures. In accordance with the standard practice in the industry, various features are not drawn to scale. In fact, the dimensions of the various features may be arbitrarily increased or reduced for clarity of discussion. Some examples of the present disclosure are described with respect to the following figures:

FIG. 1 illustrates an example environment in which example embodiments of the present disclosure can be implemented;

FIG. 2 illustrates a flowchart of a method of interference mitigation in accordance with some example embodiments of the present disclosure;

FIG. 3 illustrates a schematic diagram of an example procedure of identifying a client suffering from adjacent band interference in which example embodiments of the present disclosure can be implemented;

FIG. 4 illustrates a schematic diagram of another example procedure of identifying a client suffering from adjacent band interference in which example embodiments of the present disclosure can be implemented; and

FIG. 5 illustrates a block diagram of an access point according to embodiments of the present disclosure.

### DETAILED DESCRIPTION

As described above, great efforts are needed to mitigate the adjacent band interference caused by concurrent transmissions on adjacent bands such as the 5 GHz band and 6 GHz band. Some proposed solutions introduce state-of-art RF filters into APs to ensure proper band isolation to avoid the adjacent band interference. However, a lot of clients are not equipped with these expensive RF filters. For example, some legacy 5 GHz clients and even some new 6 GHz clients are not equipped with these RF filters. Therefore, it is desired to mitigate the adjacent band interference at the clients that are not equipped with the high-performance RF filters.

Various example embodiments of the present disclosure propose a solution to mitigate the adjacent band interference. Specifically, radio statistics indicating transmissions between an AP and a plurality of clients are obtained at the AP. Based on the radio statistics, a client suffering from adjacent band interference is identified from the plurality of clients. An indication is transmitted to at least one other client of the plurality of clients to mitigate the adjacent band interference and the at least one other client is identified based on the client. In this way, by transmitting the indication to target client(s) associated with the client identified as suffering from the adjacent band interference, the adjacent band interference can be mitigated or eliminated efficiently.

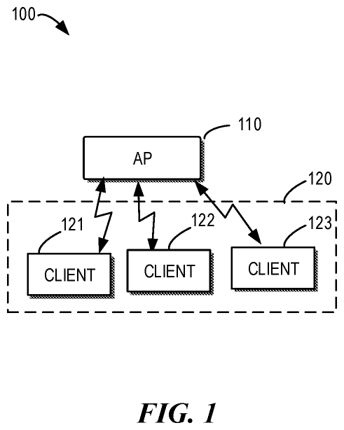

Example embodiments of the present disclosure will be described in detail below with reference to the accompanying drawings. FIG. 1 illustrates an example environment 100 in which example embodiments of the present disclosure can be implemented.

In the example environment 100, an AP 110 and a plurality of clients (e.g., client 121, 122, and 123, collectively referred to as clients 120) are shown in a wireless communication network. The AP 110 may support concurrent transmissions on adjacent bands with the plurality of clients 120.

For example, the AP 110 may support a dual-band (5 GHz and 6 GHz) or a tri-band (2.4 GHz, 5 GHz, and 6 GHz). The client 121 may operate on 5 GHz band (e.g., UNII-3), the client 122 may operate on 5 GHz band (e.g., UNII-4) and the client 123 may operate on 6 GHz band (e.g., UNII-5). In this case, when the client 121 is working on 5 GHz Channel 149 (i.e., 5735 MHz to 5755 MHz) and the client 123 is working on 6 GHz Channel 1 (i.e., 5945 MHz to 5965 MHz), the client 121 and/or the client 123 may suffer from the adjacent band interference if they are not equipped with the high-performance RF filters.

As another example, the client 121 may operate on 5 GHz UNII-3, the client 122 may operate on 5 GHz UNII-4 and the client 123 may operate on 6 GHz UNII-7. In this case, when the client 121 is working on 5 GHz Channel 149 (i.e., 5735 MHz to 5755 MHz) and the client 123 is working on 6 GHz Channel 157 (i.e., 6735 MHz to 6745 MHz), the client 121 and the client 123 may not suffer from the adjacent band interference due to a relatively wide channel space between the 5 GHz Channel 149 and 6 GHz Channel 157.

It is to be noted that although FIG. 1 illustrates only one AP and three clients in wireless communication, the illustrated number of APs and clients is only exemplary and not limiting. The environment 100 may include more APs and clients. For example, there may be another AP in the environment and one or more of the plurality of clients 120 may migrate from the AP 110 to the other AP for better transmission performance.

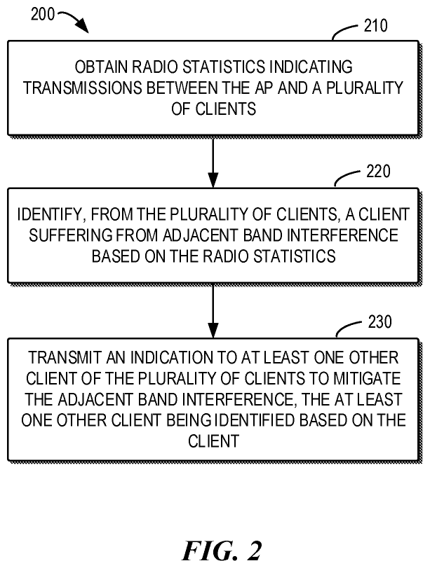

FIG. 2 illustrates a flowchart of a method 200 of interference mitigation in accordance with some example embodiments of the present disclosure. The method 200 may be performed by any suitable AP(s) to mitigate adjacent band interference for its connected clients. For the purpose of discussion, the method 200 will be described with reference to FIG. 1 to discuss example embodiments of interference mitigation. While only some blocks are shown in FIG. 2, the method 200 may comprise other operations described herein.

At block 210, the AP 110 obtains radio statistics indicating transmissions between the AP 110 and the plurality of clients 120. The radio statistics may comprise parameters associated with the transmissions between the AP 110 and one or more client among the plurality of clients 120. Alternatively or in addition, the radio statistics may comprise statistical information indicating the transmissions between the AP 110 and one or more clients among the plurality of clients 120.

In some embodiments, the AP 110 may obtain the radio statistics directly at the AP side. The AP 110 may detect the associated parameters at certain time or periodically. The AP 110 may obtain the radio statistics based on its settings or configuration. Alternatively or in addition, the AP 110 may obtain the radio statistics by performing measurements on the transmissions between the AP 110 and the plurality of clients 120.

In some embodiments, the AP 110 may obtain the radio statistics from the plurality of clients 120. The AP 110 may receive the radio statistics reported by one or more of the plurality of clients 120. The AP 110 may use 802.11k protocol to ask the plurality of clients 120 to report their respective radio statistics.

For example, for a triggered Transmit Stream/Category Measurement Report, the radio statistics may be reported via Measurement Request/Report measurement procedures between the AP 110 and the plurality of clients 120. The AP 110 may obtain channel utility reported by the plurality of clients 120 in response to the channel load request. Alternatively or in addition, the AP 110 may obtain noise floor reported by the plurality of clients 120 in response to the noise histogram request.

In some embodiments, the radio statistics may be associated with at least one of time, Modulation and Coding Scheme (MCS), Received Signal Strength Indicator (RSSI), working channel number(s), channel utility and noise floor. The radio statistics may be associated with any other suitable parameters used for characterizing the transmissions between the AP 110 and the plurality of clients 120.

At block 220, the AP 110 identifies, based on the radio statistics, a client suffering from adjacent band interference from the plurality of clients 120. The adjacent band interference may refer to interference caused by concurrent transmissions on two adjacent bands. The adjacent band interference may comprise inference between the 5 GHz band and 6 GHz band, i.e., caused by concurrent transmissions on the 5 GHz band and 6 GHz band. The adjacent band interference may comprise any other suitable interference proposed before or interference to be defined in the future. Hereinafter, the adjacent band interference may also be referred to as interference for short.

It is to be noted that, on one hand the interference may exist due to the narrow channel space between the adjacent bands. On the other hand, the interference may not exist when client(s) is equipped with advanced RF filters or due to a relatively wide channel space between working channels on the adjacent bands.

For example, when a working 5 GHz channel is near low frequency edge (i.e., left edge) of the 5 GHz band and a working 6 GHz channel is near high frequency edge (i.e., right edge) of the 6 GHz band, the interference may be avoided due to the relatively wide channel space.

Thus with the identification of client(s) suffering from the interference, which is performed at block 220, actions for interference mitigation may be performed on target client(s), thereby improving efficiency of interference mitigation at the client side.

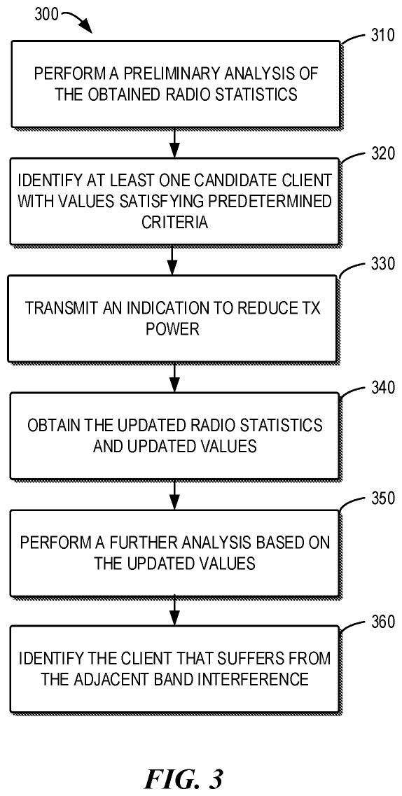

FIG. 3 illustrates a schematic diagram of an example procedure 300 of identifying a client suffering from adjacent band interference in accordance with some example embodiments of the present disclosure. Note that, one or more client may be identified as suffering from the interference and the illustrated procedure 300 is only exemplary. For the purpose of discussion, the procedure 300 will be described with reference to FIG. 1 to discuss example embodiments of identifying the client suffering from the interference.

As shown in FIG. 3, at block 310, the AP 110 may perform a preliminary analysis of the obtained radio statistics. The AP 110 may determine, for a metric associated with the adjacent band interference, a plurality of values corresponding to the plurality of clients 120 based on the radio statistics.

The metric associated with the interference may be determined from any suitable parameters characterizing the concurrent transmissions on the adjacent bands. The metric may be associated with transmissions of one or more clients in the plurality of clients 120. For example, the metric may be only associated with a respective transmission of each of the plurality of clients 120. As another example, the metric may be associated with similarity or difference among the transmissions of the plurality of clients 120. Note that, one or more metrics may be defined and the AP 110 may determine a plurality of values for each of the metrics.

Depending on the type of the metric, one or more values may be determined for one client. For example, a maximum value and a minimum value may be determined for the metric. As another example, a mean may be determined for the metric.

At block 320, the AP 110 may identify, based on the plurality of values and from the plurality of clients 120, at least one candidate client with values satisfying predetermined criteria. The at least one candidate client may be identified as potentially suffering from the interference.

The predetermined criteria may comprise threshold(s) for corresponding metric(s). Alternatively or in addition, the predetermined criteria may comprise a comprehensive threshold for some metrics or all of the metrics. For example, a model or formula may be constructed to consider the metrics comprehensively and a synthesis threshold may be used for evaluating the combined metrics.

In some embodiments, the metric may be associated with matching between signal noise ratio (SNR) and MCS, and a value of this metric may indicate a matching degree of the SNR and distribution of MCS indexes. The distribution of MCS indexes may indicate distribution of data rates of packets.

Generally, a large MCS index (i.e., high data rate) may be configured when the SNR is high so as to achieve high throughput. In other words, the matching degree of a high SNR and a distribution with more small MCS indexes may be lower than the matching degree of the high SNR and a distribution with more large MCS indexes. Thus the AP 110 may identify a client with the value of the matching degree lower than a threshold as a candidate client that is likely to suffer from the interference.

For example, when the AP 110 works with 5 GHz Channel 161 80 MHz EIRP 24.5 and 6 GHz Channel 1 80 MHz EIRP 20, the AP 110 may identify a client with SNR 25˜47 and uplink MCS5-MCS9 as one candidate client that potentially suffers from the interference.

Alternatively or in addition, the metric may be associated with noise floor of the plurality of clients 120. A value of this metric may indicate a difference between the noise floor of each client and the average noise floor. In this case, if the noise floor of a client is significantly/obviously larger than the average noise floor, the AP 110 may identify the client as a candidate client that potentially suffers from the interference.

The average noise floor may be a mean of noise floor of one or more specified clients among the plurality of clients 120. For example, the average noise floor may be a mean of the noise floor of all of the plurality of clients 120. Alternatively, the average noise floor may be a mean of the noise floor of clients working on a same band among the plurality of clients 120.

Alternatively or in addition, the metric may be associated with a number of duplicate frames transmitted by each of the plurality of clients 120 in a predetermined period. A value of this metric may indicate that whether a client has difficulty in parsing acknowledgment frame received from the AP 110.

In some embodiments, if the number of transmitted duplicates for a client is significantly/obviously larger than the average number, the AP 110 may identify the client as a candidate client that potentially suffers from the interference. Similarly, the average number may be a mean of the numbers for one or more specified clients among the plurality of clients 120.

Alternatively or in addition, if the number of transmitted duplicates for a client is larger than a threshold, the AP 110 may identify the client as a candidate client that potentially suffers from the interference. For example, if the number of uplink (UL) data retry received from a client is larger than a threshold even though the AP 110 has downlink (DL) frames to the client, the AP 110 may identify the client as a candidate client that potentially suffers from the interference.

Alternatively or in addition, the metric may be associated with Receive (Rx) errors reported by each of the plurality of clients 120. The Rx errors may comprise at least one of cyclic redundancy check (CRC) errors and physical layer (PHY) errors. A value of this metric may indicate a difference between Rx error rate of a client and an average Rx error rate. Similarly, the average Rx error rate may be a mean of Rx error rate of one or more specified clients among the plurality of clients 120.

In this case, the AP 110 may identify a client with the value larger than a threshold as a candidate client that potentially suffers from the interference. For example, if the reported CRC error rate of client 121 is significantly larger than CRC error rate of the client 122 and the client 123, the AP 110 may identify the client 121 as a candidate client that potentially suffers from the interference.

In some embodiments, as discussed above, one or more metrics may be defined and the AP 110 may determine, for each of the metrics, a plurality of values corresponding to the plurality of clients 120. The AP 110 may determine, based on values of some or all of the metrics, a comprehensive value corresponding to a client so as to identify candidate client(s) based on the comprehensive value. For example, the plurality of values may be input to a trained machine learning model to output the comprehensive value used for identifying the candidate client(s).

As shown in FIG. 3, with the one or more candidate clients being identified, the AP 110 may perform a further analysis at blocks 330-350 and thus identify the client suffering from the interference based on the further analysis at block 360.

At blocks 330, the AP 110 may transmit an indication to, among the plurality of clients 120, one or more clients associated with the identified one or more candidate clients to reduce transmit (Tx) power. In some embodiments, the one or more clients to be instructed and the one or more identified candidate clients may work on different bands.

For example, if the client 121 working on 6 GHz band is identified as a candidate client, the client 122 and the client 123 working on 5 GHz band may be instructed to reduce their Tx power. Additionally, the clients equipped with the advanced RF filters may be instructed to reduce the Tx power. Alternatively or in addition, all of the plurality of clients 120 may be instructed to reduce their respective Tx power.

In some embodiments, the indication to reduce Tx power may be transmitted via Tx power related information element (IE) in a management frame. For example, for a client working on 2.4/5 GHz band, maximum Tx power level may be indicated in Country IE in beacon and/or probe respond frames with 802.11h protocol. As another example, for a client working on 6 GHz band, Tx power limitations may be indicated in Transmit Power Envelope IE in beacon and/or probe respond frames.

At block 340, the AP 110 may obtain the updated radio statistics and determine the updated values in a similar way as in block 210. The updated radio statistics and the updated values are obtained after the Tx power of the one or more clients associated with the one or more candidate clients is reduced. For example, if the client 122 and the client 123 working on 5 GHz band are instructed to reduce their Tx power, the updated value of the matching degree of the SNR and MCS distribution for the client 121 working on 6 GHz band may be determined after the Tx power of the client 122 and client 123 has been reduced.

At block 350, the AP 110 may perform a further analysis based on the updated values. The AP 110 may perform an analysis of the updated values and the previous values to check whether the updated values of the same metric(s) are improved due to the reduction of the Tx power. For example, the AP 110 may compare the updated value of the matching degree for the client 121 with the original value to check whether the matching degree for the client 121 is improved.

Alternatively or in addition, the AP 110 may perform an analysis of the updated values and the predetermined criteria to check whether the updated values of the same metric(s) satisfy the predetermined criteria due to the reduction of the Tx power. For example, the AP 110 may check whether the value of the matching degree for the client 121 has been updated to satisfy the predetermined criteria due to the reduction of Tx power of the client 122 and client 123.

At block 360, the AP 110 may identify, from the at least one candidate client and based on the further analysis, the client that suffers from the adjacent band interference. The AP 110 may identify, from the candidate client(s), a client with updated values being improved due to the reduction of Tx power and/or a client with the values being updated to satisfy the predetermined criteria due to the reduction of Tx power as the client that suffers from the interference.

If none of the plurality of clients 120 is identified as suffering from the interference, the AP 110 may stop the procedure 300 of identifying the client(s) suffering from the interference (not shown in FIG. 3). For example, the AP 110 may perform the procedure 300 periodically and if the values of the metrics are not improved or the predetermined criteria are not met for a period, the AP 110 may stop the procedure 300 and wait for the next period.

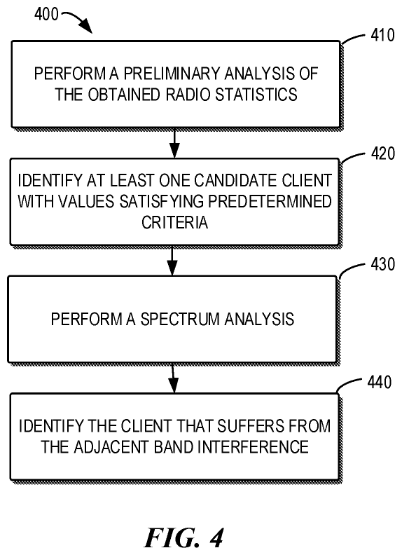

FIG. 4 illustrates a schematic diagram of an example procedure 400 of identifying a client suffering from adjacent band interference in accordance with some example embodiments of the present disclosure. For the purpose of discussion, the procedure 400 will be described with reference to FIGS. 1-3 to discuss example embodiments of identifying the client suffering from the interference.

As shown in FIG. 4, at block 410, the AP 110 may perform a preliminary analysis of the obtained radio statistics. At block 420, the AP 110 may identify, based on the plurality of values and from the plurality of clients 120, at least one candidate client with values satisfying predetermined criteria. The at least one candidate client may be identified as potentially suffering from the interference. The details of performance at block 410 and block 420 are similar to those discussed with FIG. 3 and will be omitted here.

At block 430, the AP 110 may perform a spectrum analysis for each of the candidate client(s) to check whether the interference exists in transmission(s) of the candidate client(s). The AP 110 may perform the spectrum analysis by obtaining RF minor lobe status and a simple figure showing the RF environment on different bands to investigate spectrum leakage.

Alternatively or in addition, the AP 110 may obtain a result of the spectrum analysis from other device(s) in the same wireless communication network. For example, a client sensor deployed near the plurality of clients 120 may perform the spectrum analysis and transmit the result to the AP 110.

At block 440, the AP 110 may identify, from the at least one candidate client and based on the further analysis, the client that suffers from the adjacent band interference. The AP 110 may identify, from the candidate client(s), a client with significant spectrum leakage as the client suffering from the interference.

Referring back to FIG. 2, at block 230, the AP 110 transmits an indication to at least one other client of the plurality of clients 120 to mitigate the adjacent band interference, and the at least one other client is identified based on the client identified as suffering from the interference. In some embodiments, the at least one other client to be instructed and the identified client may work on different bands. Additionally, the at least one other client to be instructed may be identified based on hardware design of the clients. Additionally, the at least one other client to be instructed may be identified based on the type of the instruction. Alternatively or additionally, the AP 110 may transmit the indication to the identified client.

In some embodiments, the indication may indicate reducing the Tx power. In this case, the at least one other client to be instructed and the client identified as suffering from the interference may work on different bands involved in the adjacent band interference. The reduction amount of the TX power may be determined based on the SNR margin of the client so as to maintain high performance of transmission. For example, if the client 121 working on 6 GHz band is identified as suffering from the interference due to improvement of its values of the metrics, the client 122 and the client 123 working on 5 GHz band may be instructed to reduce their Tx power to further mitigate the interference.

In some embodiments, the indication may indicate migrating to another AP. The AP 110 may transmit the indication to the client(s) associated with the interference. For example, if it is determined that performance of the client 121 was improved due to the reduction of Tx power of the client 122, the AP 110 may instruct the client 122 to migrate to another AP so as to protect the client 121 from the interference associated with the client 121.

As another example, the client(s) to be instructed may be the client identified as suffering from the interference. For example, the AP 110 may instruct the client 121 suffering from the interference to migrate to another AP to avoid the interference caused by concurrent transmissions from the client 122 and/or the client 123. Alternatively, if more than one client is identified as suffering from the interference, the AP 110 may instruct some of them to migrate to another AP.

In some embodiments, the indication may indicate working on a specified channel that increases a channel space between adjacent bands associated with the adjacent band interference. In this case, the client(s) to be instructed may comprise the client identified as suffering from the interference. For example, the AP 110 may instruct the client 121 suffering from the interference to work on a channel that increases the channel space to mitigate the interference. Alternatively or in addition, the AP 110 may instruct the client(s) working on different bands from the identified client to work on a channel that increases the channel space to mitigate the interference.

In some embodiments, the AP 110 may modify current channel number(s) and/or channel bandwidth to determine the channel(s) that increases the channel space between the adjacent bands and the indicate information of the channel(s) to be operated on to target client(s). The AP 110 may shift a current working channel on a low band (e.g., 5 GHz) to the lower frequency edge and/or shift a current working channel on a high band (e.g., 6 GHz) to the higher frequency edge.

In some examples, the AP 110 may preferably modify the channel(s) on 6 GHz band first. In some embodiments, the AP 110 may determine target channel(s) by modifying the channel number or bandwidth iteratively.

As discussed with FIGS. 2-4, the AP 110 may identify the client(s) suffering from the adjacent band interference based on the radio statistics and transmit indication(s) to target client(s) identified based on the identified client(s). In this way, by transmitting the indication(s) to the target client(s), the adjacent band interference can be mitigated or eliminated efficiently.

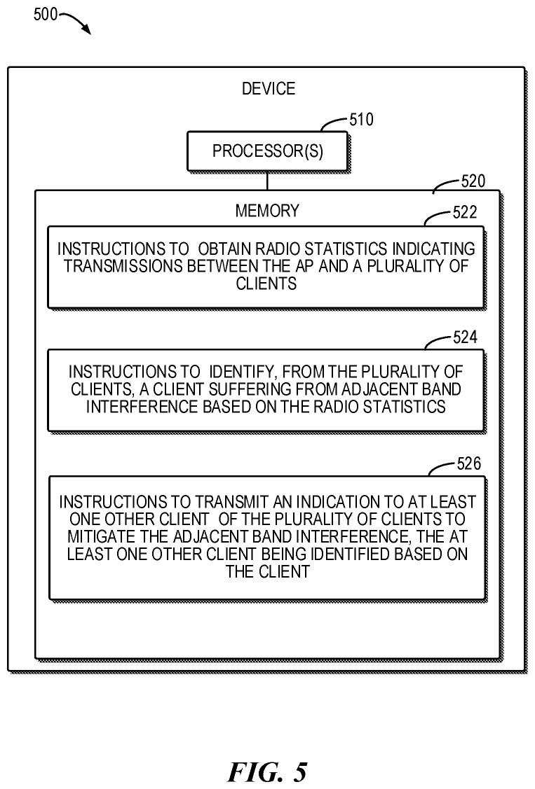

FIG. 5 illustrates a block diagram 500 of an AP according to embodiments of the present disclosure. For the purpose of discussion, the block diagram 500 will be described with reference to FIG. 1 to discuss example embodiments of the AP 110. The AP 110 comprises a processor 510 and a memory 520 coupled to the processor 510. The memory 520 stores instructions 522, 524 and 526 to cause the processor 510 to implement a method to performed at the AP 110.

As illustrated in FIG. 5, the memory 520 stores instructions 522 causing the processor 510 to obtain radio statistics indicating transmissions between the AP and a plurality of clients.

In some example embodiments, the instructions 522 causing the processor 510 to obtain the radio statistics comprise instructions to obtain the radio statistics from at least one of the AP and the plurality of clients, and wherein the radio statistics are associated with at least one of time, Modulation and Coding Scheme (MCS), Received Signal Strength Indicator (RSSI), working channel number(s), channel utility, and noise floor.

The memory 520 further stores instructions 524 causing the processor 510 to identify, from the plurality of clients, a client suffering from adjacent band interference based on the radio statistics.

In some example embodiments, the instructions 524 causing the processor 510 to identify the client suffering from adjacent band interference based on the radio statistics comprise instructions to determine, for a metric associated with the adjacent band interference, a plurality of values corresponding to the plurality of clients based on the radio statistics; identify, based on the plurality of values and from the plurality of clients, at least one candidate client with values satisfying predetermined criteria; and identify the client from the at least one candidate client based on a further analysis.

In some example embodiments, the metric is associated with at least one of: matching between signal-to-noise ratio (SNR) and MCS; noise floor; a number of duplicate frames transmitted in a predetermined period; or receive (Rx) errors.

In some example embodiments, the further analysis comprises at least one of: a spectrum analysis for each of the at least one candidate client; or an analysis of the updated values and at least one of the values and the predetermined criteria, the updated values being determined after transmit (Tx) power of one or more clients associated with the one or more candidate clients is reduced.

The memory 520 further stores instructions 526 causing the processor 510 to transmit an indication to at least one other client of the plurality of clients to mitigate the adjacent band interference, the at least one other client being identified based on the client.

In some example embodiments, the indication indicates at least one of: reducing Tx power; working on a specified channel that increases a channel space between adjacent bands associated with the adjacent band interference; or migrating to another AP.

In some example embodiments, the at least one other client and the client work on different bands associated with the adjacent band interference.

With these embodiments, by transmitting the indication to the target client(s) associated with the client identified as suffering from the adjacent band interference, the adjacent band interference can be mitigated or eliminated efficiently.

The present disclosure also provides at least one computer program product tangibly stored on a non-transitory computer-readable storage medium. The computer program product includes program codes or instructions which can be executed to carry out the method as described above with reference to FIGS. 2-4.

While some of the operations in the foregoing embodiments were implemented in hardware or software, in general the operations in the preceding embodiments can be implemented in a wide variety of configurations and architectures. Therefore, some or all of the operations in the foregoing embodiments may be performed in hardware, in software or both.

It should be noted that specific terms disclosed in the present disclosure are proposed for convenience of description and better understanding of example embodiments of the present disclosure, and the use of these specific terms may be changed to another format within the technical scope or spirit of the present disclosure.

Program codes or instructions for carrying out methods of the present disclosure may be written in any combination of one or more programming languages. These program codes or instructions may be provided to a processor or controller of a general purpose computer, special purpose computer, or other programmable data processing apparatus, such that the program codes, when executed by the processor or controller, cause the functions/operations specified in the flowcharts and/or block diagrams to be implemented. The program code or instructions may execute entirely on a machine, partly on the machine, as a stand-alone software package, partly on the machine and partly on a remote machine or entirely on the remote machine or server.

In the context of this disclosure, a computer-readable medium may be any tangible medium that may contain, or store a program for use by or in connection with an instruction execution system, apparatus, or device. The computer-readable medium may be a computer-readable signal medium or a computer-readable storage medium. A computer-readable medium may include but not limited to an electronic, magnetic, optical, electromagnetic, infrared, or semiconductor system, apparatus, or device, or any suitable combination of the foregoing. More specific examples of the computer-readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Certain features that are described in the context of separate embodiments may also be implemented in combination in a single implementation. Conversely, various features that are described in the context of a single implementation may also be implemented in multiple embodiments separately or in any suitable sub-combination.

In the foregoing Detailed Description of the present disclosure, reference is made to the accompanying drawings that form a part hereof, and in which is shown by way of illustration how examples of the disclosure may be practiced. These examples are described in sufficient detail to enable those of ordinary skill in the art to practice the examples of this disclosure, and it is to be understood that other examples may be utilized and that process, electrical, and/or structural changes may be made without departing from the scope of the present disclosure.

What is claimed:

1. A method for an access point (AP), comprising:
obtaining radio statistics indicating transmissions between the AP and a plurality of clients;
identifying, from the plurality of clients, a client suffering from adjacent band interference based on the radio statistics; and
transmitting an indication to at least one other client of the plurality of clients to mitigate the adjacent band interference, the at least one other client being identified based on the client.

2. The method according to claim 1, wherein obtaining the radio statistics comprises obtaining the radio statistics from at least one of the AP and the plurality of clients, and wherein the radio statistics are associated with at least one of time, Modulation and Coding Scheme (MCS), Received Signal Strength Indicator (RSSI), working channel number(s), channel utility, and noise floor.

3. The method according to claim 1, wherein identifying the client suffering from the adjacent band interference based on the radio statistics comprises:
determining, for a metric associated with the adjacent band interference, a plurality of values corresponding to the plurality of clients based on the radio statistics;
identifying, based on the plurality of values and from the plurality of clients, at least one candidate client with values satisfying predetermined criteria; and
identifying the client from the at least one candidate client based on a further analysis.

4. The method according to claim 3, wherein the metric is associated with at least one of:
matching between signal-to-noise ratio (SNR) and MCS;
noise floor;
a number of duplicate frames transmitted in a predetermined period; or
receive (Rx) errors.

5. The method according to claim 3, wherein the further analysis comprises at least one of:
a spectrum analysis for each of the at least one candidate client; or
an analysis of the updated values and at least one of the values and the predetermined criteria, the updated values being determined after transmit (Tx) power of one or more clients associated with the one or more candidate clients is reduced.

6. The method according to claim 1, wherein the indication indicates at least one of:
reducing Tx power;
working on a specified channel that increases a channel space between adjacent bands associated with the adjacent band interference; or
migrating to another AP.

7. The method according to claim 1, wherein the at least one other client and the client work on different bands associated with the adjacent band interference.

8. An access point comprising:
at least one processor; and
a memory coupled to the at least one processor, the memory storing instructions to cause the at least one processor to perform acts comprising:
obtaining radio statistics indicating transmissions between the AP and a plurality of clients;
identifying, from the plurality of clients, a client suffering from adjacent band interference based on the radio statistics; and
transmitting an indication to at least one other client of the plurality of clients to mitigate the adjacent band interference, the at least one other client being identified based on the client.

9. The access point of claim 8, wherein obtaining the radio statistics comprises obtaining the radio statistics from at least one of the AP and the plurality of clients, and wherein the radio statistics are associated with at least one of time, Modulation and Coding Scheme (MCS), Received Signal Strength Indicator (RSSI), working channel number(s), channel utility, and noise floor.

10. The access point of claim 8, wherein identifying the client suffering from the adjacent band interference based on the radio statistics comprises:
determining, for a metric associated with the adjacent band interference, a plurality of values corresponding to the plurality of clients based on the radio statistics;
identifying, based on the plurality of values and from the plurality of clients, at least one candidate client with values satisfying predetermined criteria; and
identifying the client from the at least one candidate client based on a further analysis.

11. The access point of claim 10, wherein the metric is associated with at least one of:
matching between signal-to-noise ratio (SNR) and MCS;
noise floor;
a number of duplicate frames transmitted in a predetermined period; or
receive (Rx) errors.

12. The access point of claim 10, wherein the further analysis comprises at least one of:
a spectrum analysis for each of the at least one candidate client; or
an analysis of the updated values and at least one of the values and the predetermined criteria, the updated values being determined after transmit (Tx) power of one or more clients associated with the one or more candidate clients is reduced.

13. The access point of claim 8, wherein the indication indicates at least one of:
reducing Tx power;
working on a specified channel that increases a channel space between adjacent bands associated with the adjacent band interference; or
migrating to another AP.

14. The access point of claim 8, wherein the at least one other client and the client work on different bands associated with the adjacent band interference.

15. A non-transitory computer-readable medium comprising instructions stored thereon which, when executed by an apparatus, cause the apparatus to:
obtain radio statistics indicating transmissions between the AP and a plurality of clients;
identify, from the plurality of clients, a client suffering from adjacent band interference based on the radio statistics; and
transmit an indication to at least one other client of the plurality of clients to mitigate the adjacent band interference, the at least one other client being identified based on the client.

16. The computer-readable medium of claim 15, wherein the instructions causing the apparatus to obtain the radio statistics comprise instructions causing the apparatus to obtain the radio statistics from at least one of the AP and the plurality of clients, and wherein the radio statistics are associated with at least one of time, Modulation and Coding Scheme (MCS), Received Signal Strength Indicator (RSSI), working channel number(s), channel utility, and noise floor.

17. The computer-readable medium of claim 15, wherein the instructions causing the apparatus to identify the client suffering from the adjacent band interference based on the radio statistics comprise instructions causing the apparatus to:
determine, for a metric associated with the adjacent band interference, a plurality of values corresponding to the plurality of clients based on the radio statistics;
identify, based on the plurality of values and from the plurality of clients, at least one candidate client with values satisfying predetermined criteria; and
identify the client from the at least one candidate client based on a further analysis.

18. The computer-readable medium of claim 17, wherein the metric is associated with at least one of:
matching between signal-to-noise ratio (SNR) and MCS;
noise floor;
a number of duplicate frames transmitted in a predetermined period; or
receive (Rx) errors.

19. The computer-readable medium of claim 17, wherein the further analysis comprises at least one of:
a spectrum analysis for each of the at least one candidate client; or
an analysis of the updated values and at least one of the values and the predetermined criteria, the updated values being determined after transmit (Tx) power of one or more clients associated with the one or more candidate clients is reduced.

20. The computer-readable medium of claim 15, wherein the indication indicates at least one of:
reducing Tx power;
working on a specified channel that increases a channel space between adjacent bands associated with the adjacent band interference; or
migrating to another AP.
